(19) United States
(12) Patent Application Publication
(10) Pub. No.: US 2006/0266295 A1
(43) Pub. Date: Nov. 30, 2006

(54) BIRD ACCOMMODATION HAVING A BIRDCALL

(75) Inventor: Robert S. McDarren, Newtown, CT (US)

Correspondence Address: SENNIGER POWERS, ONE METROPOLITAN SQUARE, 16TH FLOOR, ST LOUIS, MO, 63102, US

(73) Assignee: LINK GROUP INTERNATIONAL, LLP, Newtown, CT (US)

(21) Appl. No.: 11/420,330

(22) Filed: May 25, 2006

Related U.S. Application Data
(60) Provisional application No. 60/684,254, filed on May 25, 2005.

(51) Int. Cl. A01K 61/02

(52) U.S. Cl. 119/57.8

(57) ABSTRACT

An apparatus for attracting wild birds comprises a bird accommodation for use by wild birds and an audio device. The audio device is programmed to emit at least one birdcall for attracting wild birds to the accommodation.

### REFERENCE TO RELATED APPLICATION

This application claims priority from U.S. provisional application Ser. No. 60/684,254 filed on May 25, 2005, which is incorporated in its entirety herein by reference.

### BACKGROUND OF THE INVENTION

This invention relates to accommodations for birds, and in particular to accommodations for birds having an audio device programmed to emit a birdcall for attracting birds to the accommodation.

Birdwatching is an activity enjoyed by many people. To attract birds for viewing, it is common for bird watchers to place bird accommodations, such as birdhouses, birdbaths and/or bird feeders, in an area in which they wish to attract birds. For example, a bird watcher may place a bird feeder near and in sight of a window. As a result, the bird watcher can watch various species of birds that come to feed at the feeder. However, many bird watchers favor watching a particular species of bird over others. Since conventional bird accommodations are passive and rely solely on their presence and accessibility to attract birds to the accommodation, bird watchers are unable to actively attract the particular species of bird they most enjoy watching to the accommodation.

### SUMMARY OF THE INVENTION

In one aspect, the present invention is directed to an apparatus for attracting wild birds generally comprising a bird accommodation for use by wild birds and an audio device. The device is programmed to emit at least one birdcall for attracting wild birds to the accommodation.

In another aspect, the present invention is directed to a bird feeder for wild birds generally comprising a reservoir for holding a supply of bird feed, and an audio device. The audio device is programmed to emit at least one birdcall for attracting wild birds to the bird feeder.

In yet another aspect, the present invention is directed to a birdcall in combination with a bird accommodation. The birdcall generally comprises an audio device programmed with at least one birdcall and capable of emitting the birdcall for attracting wild birds of particular species of bird having the birdcall to the accommodation.

Other objects and features will be in part apparent and in part pointed out hereinafter.

### BRIEF DESCRIPTION OF THE DRAWINGS

FIG. 1 is a perspective of a bird feeder;

FIG. 2 is a side elevation of the bird feeder having a portion broken away to show an audio device;

FIG. 3 is a top view of the bird feeder;

FIG. 4 is a bottom view of the bird feeder;

FIG. 5 is an exploded view of the bird feeder;

FIG. 6 is a perspective of the bird feeder showing an end cap in an open position;

FIG. 7A is an enlarged view of a cover having a door in a closed position;

FIG. 7B is a view similar to FIG. 7A except the door is in an open position;

FIG. 8 is a perspective of a birdhouse having a portion broken away to show an audio device; and

FIG. 9 is a perspective of a birdbath having a portion broken away to show an audio device.

Corresponding reference characters indicate corresponding parts throughout the drawings.

### DETAILED DESCRIPTION OF THE INVENTION

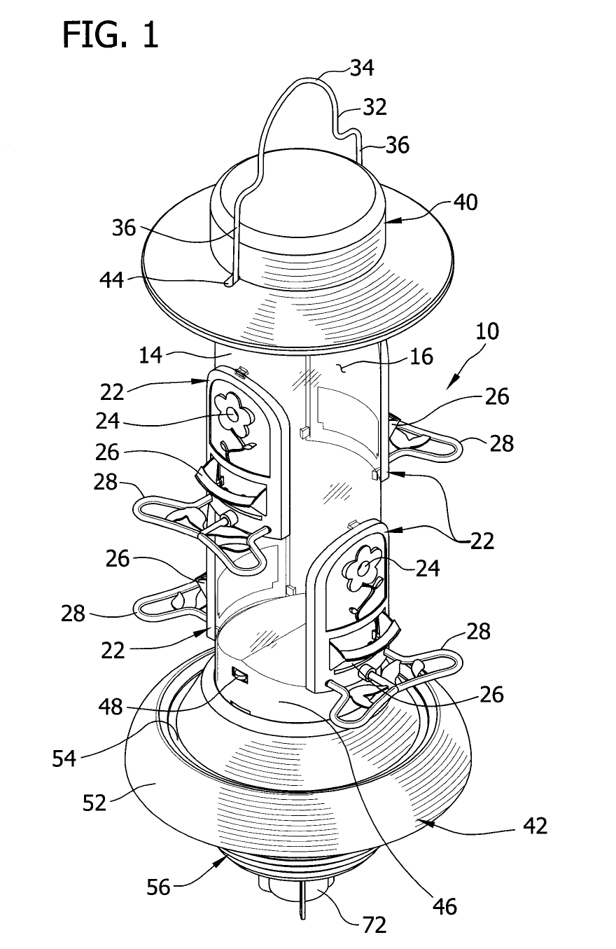

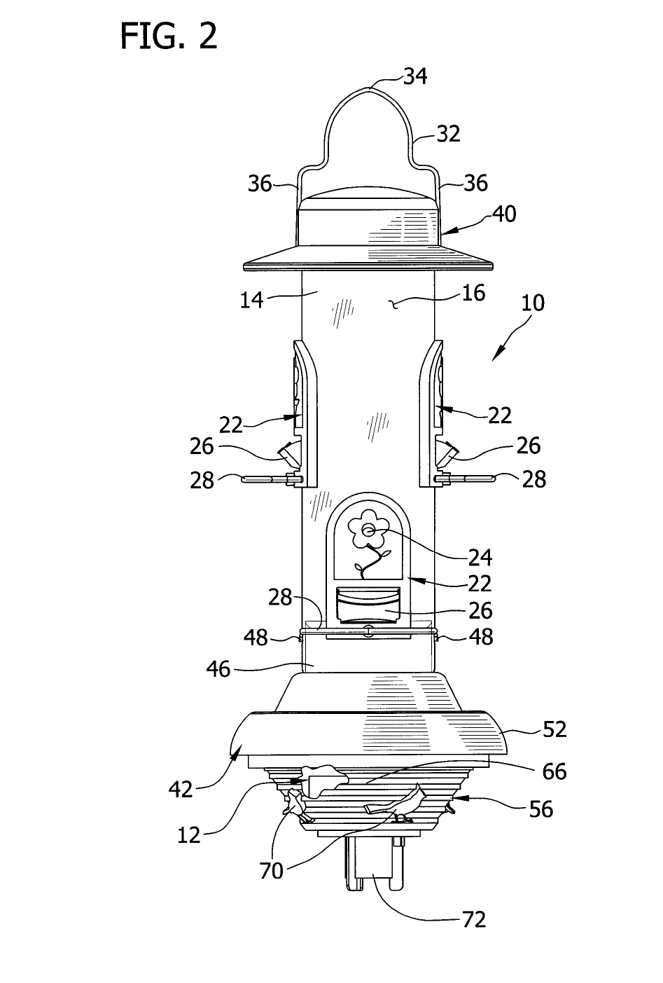

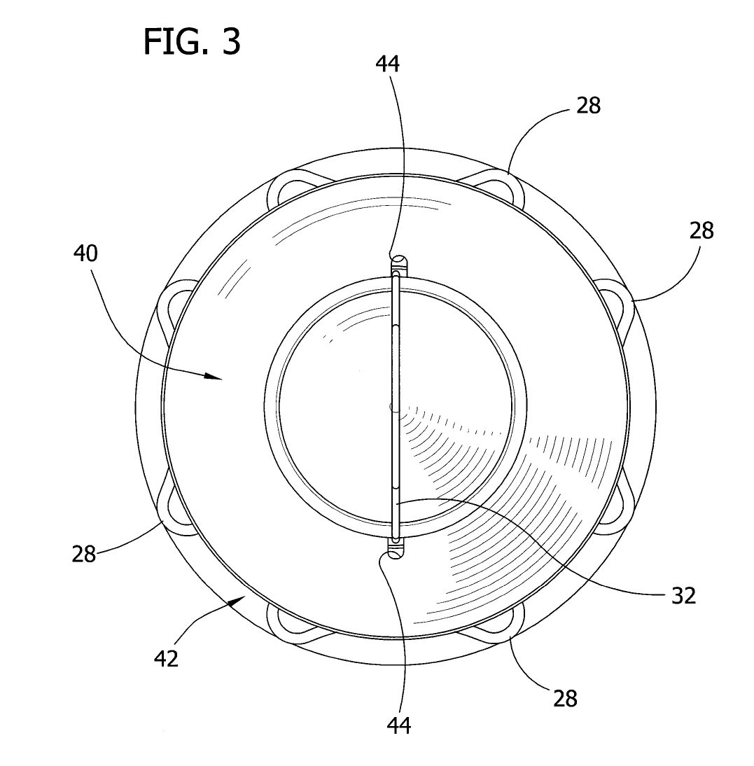

Referring now to the drawings and in particular to FIGS. 1 and 2, a bird feeder (generally, a bird accommodation) of one embodiment, indicated generally at 10, includes an audio device, indicated generally at 12, having at least one pre-programmed birdcall for attracting wild birds to the bird feeder. A portion of the feeder 10 is broken away in FIG. 2 to show the audio device 12. The bird feeder 10 comprises an elongate, cylindric tube 14 defining a reservoir 16 for holding a supply of bird feed (not shown). The tube 14 may be formed from transparent plastic which allows visual assessment of the quantity of bird feed within the reservoir 16. It is understood, however, that the tube 14 can be made from an opaque material and can have other shapes and configurations.

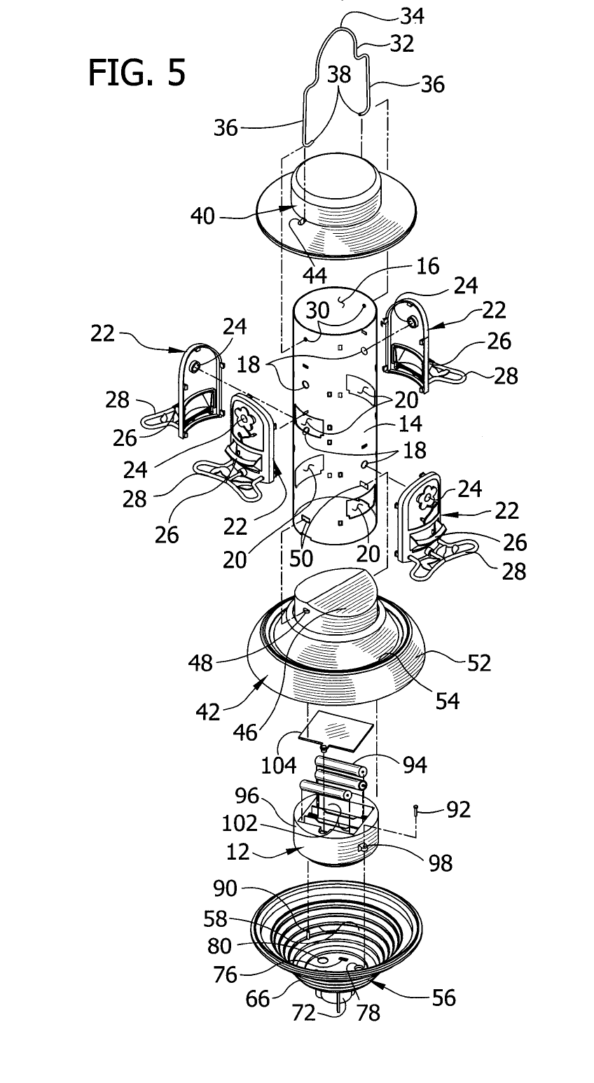

The bird feeder 10 of one embodiment is adapted to hold small bird feed, large bird feed, or both. As a result, the bird feed selected for placement in the bird feeder 10 can be matched to the feed preferences of the bird species selected to be called to the feeder by the audio device 12. As best shown in FIG. 5, the tube 14 of the bird feeder 10 includes four circular apertures 18 sized and shaped for providing birds access to small bird feed (e.g., thistle) held within the reservoir 16. The apertures 18 are positioned on the tube 14 in opposed pairs such that one pair of opposed apertures are located in the upper half of the tube and another pair of opposed apertures are located in the lower half of the tube. The apertures 18 in the upper half of the tube 18 are spaced on the tube about 90 from the apertures in the lower half of the tube. The tube 14 further includes four rectangular openings 20 for providing birds access to larger bird feed (e.g., sunflower seeds) or mixed feed (i.e., both small and large bird feed) held with the reservoir 16. Each of the rectangular openings 20 is adjacent to and below one of the circular apertures 18. It should be understood that the bird feeder 10 could have fewer or more apertures 18 and/or openings 20 than those shown in the illustrated configuration. It should also be understood that the apertures 18 and openings 20 can be disposed at other locations on the tube 14 or have other shapes than those illustrated.

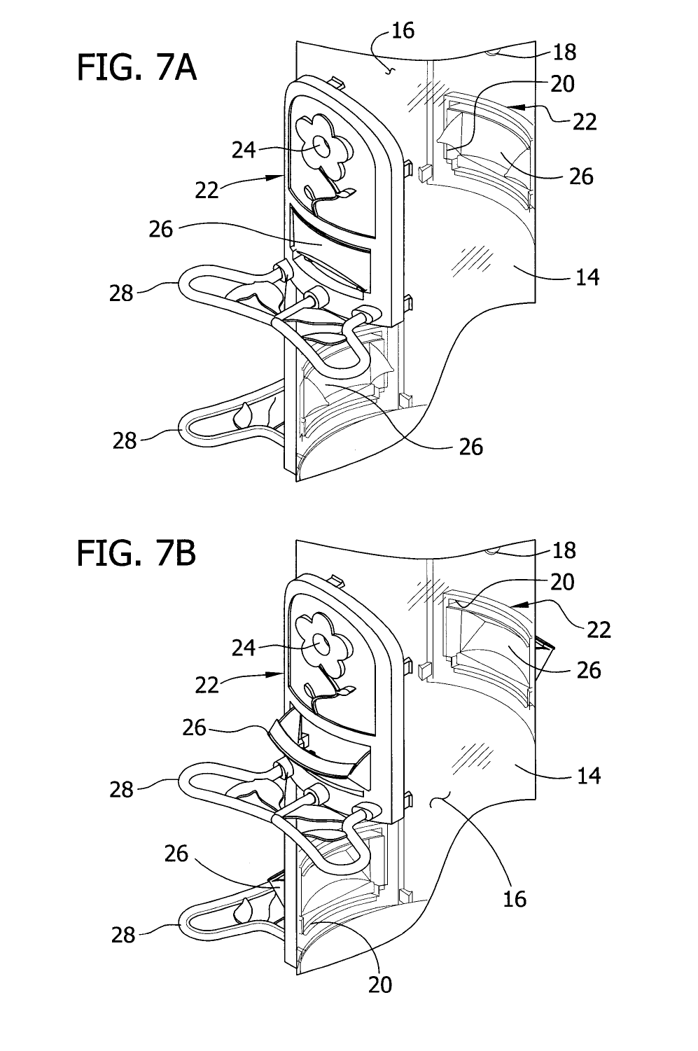

Four covers, generally indicated at 22, are mounted to the tube 14 such that an aperture 24 in the cover aligns with one of the apertures 18 in the tube 14, and a door 26 of the cover aligns with the respective rectangular opening 20. The covers 22 are adapted for snap connection with the tube 14 but can be attached in other ways (e.g., adhesive). Each door 26 on the cover 22 is pivotally connected to the cover 22 so that it can be selectively pivoted between an open position wherein a portion of the door is spaced from the tube for allowing access to the bird feed in the reservoir 16 by birds through the rectangular opening 20 (FIGS. 1, 2, and 7B), and a closed position for inhibiting access to the bird feed in the reservoir by birds through the rectangular opening 20 (FIG. 7A). As best illustrated in FIGS. 7A and 7B, each cover 22 also includes a stand 28 adapted to support a bird so that the bird can access bird feed held in the reservoir 16 of the tube 14 through either the aperture 18 or the opening 20 while the bird is positioned on the stand.

Referring again to FIG. 5, the tube 14 of this embodiment also includes two holes 30 near the top of the tube for allowing a hanger 32 to be connected to the bird feeder 10. The hanger 32 allows the bird feeder 10 to be hung from a bird feeder support, a tree, or any other suitable object. The hanger 32 includes an arcuate portion 34 and two arms 36 extending from the arcuate portion. The ends 38 of the arms 36 are bent towards each other for insertion into the holes 30 in the tube 14 to thereby connect the hanger 32 to the tube. The arcuate portion 34 is sized and shaped for engagement with, for example, a branch of a tree or a hook of a bird feeder support.

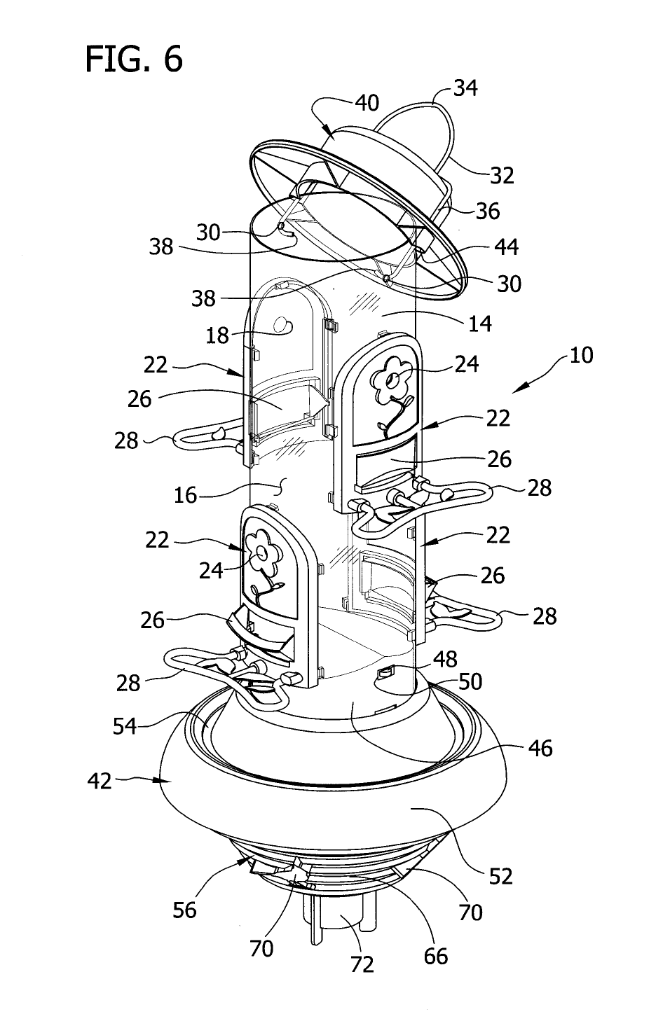

The feeder also includes a first end cap, generally indicated at 40, for closing the top of the tube 14 and a second end cap, generally indicated at 42, for closing the bottom of the tube. The first end cap 40 includes two opposed openings 44 for allowing the arms 36 of the hanger 32 to extend through the first end cap (FIG. 1). As a result, the first end cap 40 can be slid upward along the arms 36 of the hanger 32 thereby exposing the tube reservoir 16 so that the bird feed can be placed in the reservoir without removing the hanger and the first end cap from the bird feeder 10 (FIG. 6). The hanger 32 and the first end cap 40 can be removed from the bird feeder 10 by pulling the arms 36 of the hanger apart thereby moving the bent ends 38 of the arms to a position free of the openings 30 in the tube. With the bent ends 38 removed from the openings 30, the hanger 32 and first end cap 40 can be easily separated from the tube 14.

The second end cap 42 includes a conical base 52 having an annular recess 54 for catching seed that may drop, and a cylindrical plug 46 extending upward from the base. The plug 46 is sized and shaped for insertion into the bottom of the tube 14. The upper surface of the plug 46, which is disposed within the reservoir 16, has two sloping surfaces for directing seed towards the two lower rectangular openings 20, and a central ridge dividing the two sloping surfaces. The plug 46 includes two opposed detents 48 extending outwardly from its side for snap-connection with two rectangular openings 50 formed in the tube 14 for securing the second end cap 42 to the tube.

With reference to FIGS. 1, 2, 4, and 5, the bird feeder 10 also includes a housing, generally indicated at 56, having a hollow interior 58 for housing the audio device 12. The housing is generally frustoconical in shape having a generally flat, lower surface 62, a tapered sidewall 66 extending upward from the lower surface, and a flange 68 attached to an edge of the sidewall opposite the lower surface. The housing 56 is selectively detachable from the base 52 of the second end cap 42 by rotating the housing with respect to the base. The housing 56 can be attached to the base 52 in other ways, such as by bolts, or alternatively, permanently affixed. The sidewall 66 of the housing 56 includes four three-dimensional depictions 70 of birds. In the illustrated configurations, each of the bird depictions 70 are substantially the same. However, it is understood that the bird depictions can be different. In addition, more or fewer bird depictions 70 can be disposed on the housing 56.

The generally flat, lower surface 62 of the housing 56 includes a cylindric support receiver 72 defining a socket 74 for receiving an end of a pole (not shown) for supporting the bird feeder 10. The socket 74 of the illustrated configuration is sized and shaped for receiving the end of a one-inch diameter pole but the socket can have other sizes and shapes. Three apertures 76, 78, 80 are located in the lower surface 62 of the housing 56 for allowing two switches 82, 84 and a light sensor 86 to pass through the housing. The switches 82, 84 and light sensor 86 are described in more detail below. The lower surface 62 also includes a plurality of speaker holes 88 for allowing the birdcall to propagate from within the housing 56.

The interior 58 of the housing 56 is sized and shaped for receiving the audio device 12 and includes two opposed mounts 90 affixed to the interior of the sidewall 66 (FIG. 5). The mounts 90 are adapted to receive bolts 92 for bolting the audio device 12 to the housing 56. The audio device 12 includes a prerecorded sound chip (not shown), a circuit board (not shown), a source of electrical power 94 (e.g., batteries), a speaker (not shown), and a plastic case 96 for containing the components of the audio device. The audio device 12 may be mounted on or adjacent the reservoir 16 in other ways without departing from the scope of this invention.

With reference still to FIG. 5, the case 96 of the audio device 12 includes two mounts 98 for aligning with the mounts 90 on the housing 56 for bolting the case to the housing. The case 96 also includes a plurality of speaker holes (not shown). The speaker holes in the case 96 generally align with the speaker holes 88 in the housing 56 when the case is mounted to the housing. As a result, the birdcall emitted from the speaker is substantially undistorted by the case 96 and the housing 56. The case 96 further includes a battery compartment 102 sized and shaped for holding three AA batteries 94. The battery compartment 102 has a removable lid 104 for facilitating replacement of the batteries 94. The lid 104 faces outwardly when the housing 56 is removed from the base 52 of the bird feeder 10 so that the batteries 94 can be replaced without having to remove the case 96 from the housing. It is understood that other types of power sources (e.g., AC) or different types of batteries could be used without departing from the scope of this invention.

The sound chip of the audio device 12 is programmed with ten birdcalls for emitting the birdcalls to attract wild birds to the feeder 10. As used herein, a birdcall includes the sounds (e.g., calls, songs) made by a bird. In one embodiment, the birdcalls are authentic pre-recorded birdcalls. Authentic pre-recorded birdcalls may be obtained from the Borror Laboratory of Bioacoustics of The Ohio State University in Columbus, Ohio. It is understood, however, that the birdcalls could be obtained from other sources or recorded directly from birds without departing from the scope of this invention. In another embodiment, the birdcalls stored in the sound chip are reproductions of birdcalls. In other words, the birdcalls are generated instead of being recorded from actual birds. The speaker is connected to the sound chip via the circuit board so that the birdcalls stored in the sound chip can be emitted through the speaker.

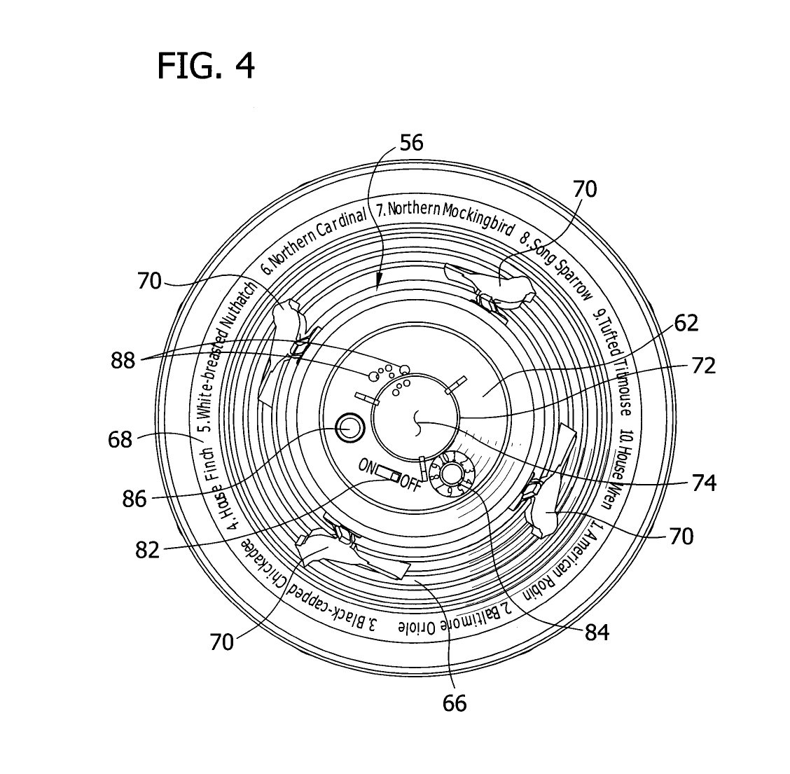

The audio device 12 includes an on/off switch 82 for turning the birdcall on or off (FIG. 4). The switch 82 passes through one of the apertures 76 in the lower surface 62 of the housing 56 so that it is easily accessible. The on and off positions of the switch 82 are clearly identified by indicia located on the lower surface 62 of the housing 56 adjacent the respective positions of the switch. In the on position for this configuration, the audio device 12 cycles through an active stage wherein the device emits a birdcall for attracting birds to the bird feeder and inactive stage wherein the device is idle (i.e., does not emit a birdcall). In the active stage, the audio device 12 emits approximately twenty individual birdcalls in succession. In this embodiment, the successive birdcalls are of the same species. But it is understood that the birdcalls could be of two or more species without departing from the scope of this invention. In the inactive stage, the audio device 12 is idle for between about twelve minutes and about fifteen minutes in duration. It is understood that the active and inactive stages of the audio device 12 can vary in duration without departing from the scope of this invention, and that the inactive state can be eliminated.

A second switch 84 passes through one of the apertures 78 in the lower surface 62 of the housing 56 for enabling selection of a particular birdcall from the ten birdcalls stored on the sound chip for attracting wild birds of the selected species to the bird feeder 10. The switch 84 has a plurality of positions which correspond to references numbers (i.e., 1, 2, 3, . . . 10) printed on the lower surface 62 of the housing 56 adjacent the switch. The names of the specific species of bird corresponding to each reference number are printed on the outward facing side of the flange 68 of the base 52. In the illustrated configuration, the switch 78 has ten different positions which correspond to the ten difference birdcalls stored on the sound chip. The various positions of the switch 78 correspond to the following species of bird:

1. American Robin

2. Baltimore Oriole

3. Black-capped Chickadee

4. House Finch

5. White-breasted Nuthatch

6. Northern Cardinal

7. Northern Mockingbird

8. Song Sparrow

9. Tufted Titmouse

10. House Wren

It is understood, that the audio device 12 may be capable of emitting birdcalls of more or less species of bird and/or different species of birds than those listed. It is further understood that in this configuration the birdcall is fully automatic having no function to allow a user to record additional species. However, such a feature could be included within the scope of the invention.

In this configuration, the light sensor 86 of the audio device 12 also extends outwardly through one of the apertures 80 in the lower surface 62 of the housing 56. The light sensor 86 is connected to the circuit board so that the audio device 12 is only operable when the sensor senses light and inoperable when the sensor does not sense light. As a result, the audio device 12 of the present embodiment is operable only when there is a sufficient amount of light present at the bird feeder to observe birds. In addition, the advantage of having the audio device 12 inoperable during the evening hours when individuals within audible range of the device are trying to sleep is apparent. Moreover, the light sensor 86 preserves battery life by rendering the audio device 12 inoperable during a time most individuals would not be watching birds. The light sensor 86 is sensitive to sunlight and other light sources.

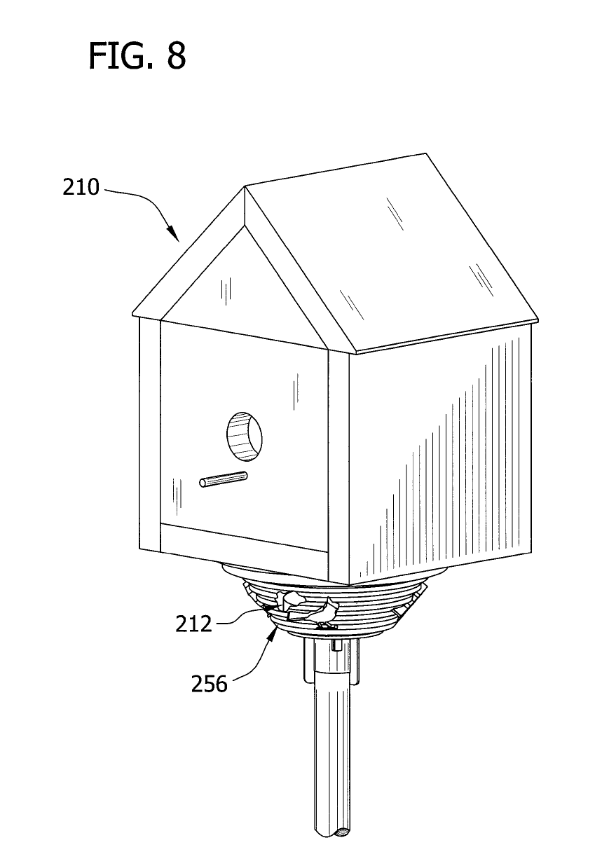

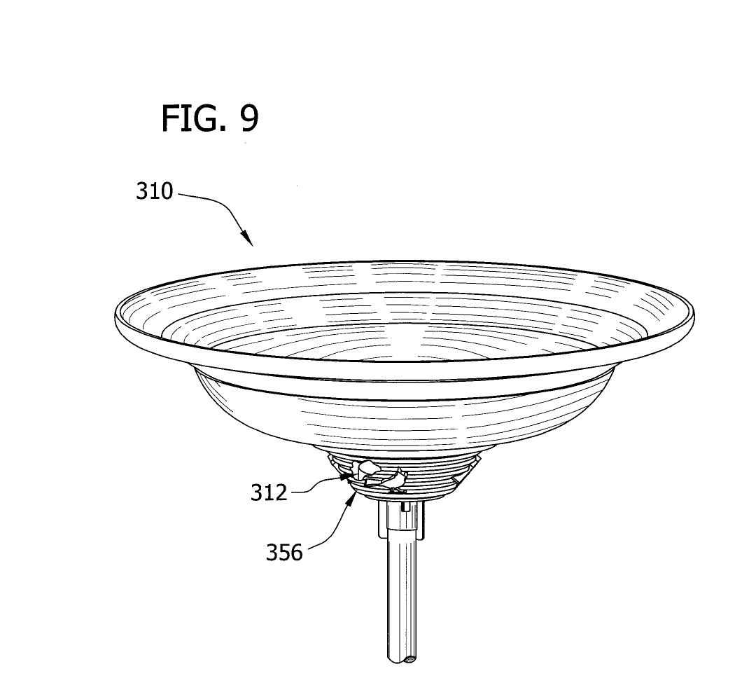

FIGS. 8 and 9 illustrates alternative bird accommodations including a birdhouse 210 and a birdbath 310, respectively. Both the birdhouse 210 and the birdbath 310 include an audio device 212, 312 for emitting birdcalls to attract birds. As shown, the birdhouse 210 and birdbath 310 include housings 256, 356 (parts of which are broken away) for housing the audio devices 212, 312. The audio devices 212, 312 and housings 256, 356 are substantially the same as shown and described above with respect to the bird feeder 10 and therefore will not be described in detail.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above accommodations without departing from the scope of the invention, it is intended that all matter contained in the above description and shown in the accompanying drawings shall be interpreted as illustrative and not in a limiting sense.

What is claimed is:

1. An apparatus for attracting wild birds comprising a bird accommodation for use by wild birds and an audio device, the device being programmed to emit at least one birdcall for attracting wild birds to the accommodation.

2. The apparatus as set forth in claim 1 wherein said birdcall is a pre-recorded authentic birdcall.

3. The apparatus as set forth in claim 1 wherein said audio device is programmed to emit a birdcall of a specific species of bird for attracting birds of said species to the accommodation.

4. The apparatus as set forth in claim 3 wherein said audio device is programmed to emit a plurality of birdcalls for attracting birds of a plurality of species to the accommodation.

5. The apparatus as set forth in claim 4 wherein the device includes a switch having a plurality of positions to enable selection and emission of a particular birdcall from said plurality of birdcalls for attracting a specific species of bird.

6. The apparatus as set forth in claim 5 further comprising indicia adjacent each of the switch positions indicating the species of bird corresponding to the particular birdcall.

7. The apparatus as set forth in claim 1 wherein said audio device is programmed to cycle through an active stage wherein said device emits a birdcall and an inactive stage wherein said device is idle.

8. The apparatus as set forth in claim 7 wherein in said active stage the audio device emits approximately 20 individual birdcalls of the same species.

9. The apparatus as set forth in claim 7 wherein said inactive stage is between about 12 minutes and about 15 minutes in duration.

10. The apparatus as set forth in claim 1 further comprising a sensor for sensing light, the sensor being connected to the audio device such that the audio device is operable when the sensor senses light and inoperable when the sensor does not sense light.

11. The apparatus as set forth in claim 1 wherein the accommodation includes a housing for the audio device, the housing being selectively separable from the accommodation.

12. The apparatus as set forth in claim 1 wherein the accommodation is selected from a group consisting of a bird feeder, a birdhouse, and a birdbath.

13. A bird feeder for wild birds comprising a reservoir for holding a supply of bird feed, and an audio device, the device being programmed to emit at least one birdcall for attracting wild birds to the bird feeder.

14. The bird feeder as set forth in claim 13 wherein the birdcall is a pre-recorded authentic birdcall.

15. The bird feeder as set forth in claim 13 wherein the reservoir includes an elongate tube for holding the bird feed, the tube having at least one opening for allowing access to the bird feed by birds, and first and second end caps for capping the ends of the tube.

16. The bird feeder as set forth in claim 15 wherein the feeder further comprises a stand affixed to the tube adjacent the opening, the stand being adapted to support a bird so that the bird can access bird feed held in the tube through the opening while the bird is standing on said stand.

17. The bird feeder as set forth in claim 15 wherein the tube includes a first opening and a second opening smaller than the first opening.

18. The bird feeder as set forth in claim 17 wherein the tube further includes a plurality of doors, the doors being selectively moveable between an open position wherein a portion of the door is spaced from the tube for allowing access to the bird feed by birds, and a close position for inhibiting access to the bird feed by birds.

19. The bird feeder as set forth in claim 13 in combination with a supply of bird feed.

20. The combination as set forth in claim 19 wherein the supply of bird feed is thistle.

21. The combination as set forth in claim 19 wherein the supply of bird feed is suitable for the same species of bird to which the audio device is programmed to attract by emitting the birdcall.

22. A birdcall in combination with a bird accommodation, the birdcall comprising an audio device programmed with at least one birdcall and capable of emitting said birdcall for attracting wild birds of particular species of bird having said birdcall to the accommodation.

23. The combination as set forth in claim 22 wherein said birdcall is a pre-recorded authentic birdcall.

24. The combination as set forth in claim 22 wherein the audio device is programmed with a plurality of birdcalls.

25. The combination as set forth in claim 24 wherein the audio device further comprises a switch having a plurality of positions to enable selection and emission of a particular birdcall from the plurality of birdcalls.

26. The combination as set forth in claim 25 wherein the audio device further comprises indicia adjacent each of the switch positions indicating the species of bird corresponding to the particular birdcall.

27. The combination as set forth in claim 22 wherein the bird accommodation is selected from a group consisting of a bird feeder, a birdhouse, and a birdbath.
